(19) United States
(12) Patent Application Publication
(10) Pub. No.: US 2026/0219674 A1
(43) Pub. Date: Jul. 30, 2026

(54) NAVIGATION CONTROL SYSTEM, NAVIGATION CONTROL METHOD, AND PROGRAM

(71) Applicant: NEC Corporation, Tokyo (JP)

(72) Inventors: Kenichi KIJIMA, Tokyo (JP); Tetsuya TANABIKI, Tokyo (JP); Eiichi TOKUMI, Tokyo (JP); Takahiro MIZUTA, Tokyo (JP); Taichi SEISHI, Tokyo (JP); Takuya NOMURA, Tokyo (JP); Takumi KAMIYAMA, Tokyo (JP)

(73) Assignee: NEC Corporation, Tokyo (JP)

(21) Appl. No.: 19/143,943

(22) PCT Filed: Dec. 12, 2023
(86) PCT No.: PCT/JP2023/044506

§ 371 Date: Jun. 27, 2025

(30) Foreign Application Priority Data
Mar. 16, 2023 (JP) 2023-042219

(51) Int. Cl. G05D 1/622; G05D 1/248; G05D 1/693; G05D 107/13; G05D 109/20; G05D 111/10; G06T 7/70

(52) U.S. Cl. CPC G05D 1/622; G05D 1/248; G05D 1/693; G06T 7/70; G05D 2107/13; G05D 2109/20; G05D 2111/10; G06T 2207/10032

(57) ABSTRACT

This navigation control system includes: a detection unit; an identification unit; a determination unit; and a sharing processing unit. The detection unit detects a first moving body that is possibly outside the range of control, on the basis of an image or a signal acquired within a predetermined region. The identification unit identifies whether the first moving body is a control target, on the basis of control information that is shared with other control system. The determination unit, if the first moving body is not identified as a control target, determines whether an avoidance operation of a second moving body, which is a control target, is necessary, on the basis of the position or the movement of the first moving body. The sharing processing unit shares with the other control system the control information that includes information related to whether the avoidance operation is necessary.

### TECHNICAL FIELD

The present disclosure relates to a navigation control system, a navigation control method, and a program.

### BACKGROUND ART

In social life, for example, moving bodies using a new technology, such as a flying object called a drone or an unmanned air system (UAS) have been widespread. With the spread of such a moving body, a mechanism for controlling navigation of the moving body is also developed.

For example, a navigation control system called an unmanned air system traffic management (UTM) is developed. The UTM aims to safely control navigation of a plurality of drones controlled by an administrator.

As related art, for example, a system described in PTL 1 includes an image interrogator that identifies possible collision threats for an aircraft and provides an operation for avoiding the recognized threats.

Furthermore, the technique described in PTL 2 detects another flying object existing within a predetermined range from a flying object, identifies a type of the another flying object, and determines a possibility that the flying object and the another flying object collide, based on an attribute related to a movement of the flying object.

### CITATION LIST

### Patent Literature

PTL 1: JP 2009-530159 A

PTL 2: WO 2019/093198 A1

### SUMMARY OF INVENTION

However, there is a possibility that a moving body that is not a control target (outside the control) exists, in a region where a moving body controlled by a predetermined administrator moves. In a case where such a moving body outside the control exists, it is desirable for the administrator to appropriately recognize the moving body.

In view of the above problems, an object of the present disclosure is to provide a navigation control system or the like that can suitably use information related to a status of a moving body that is a control target.

The navigation control system according to the present disclosure includes a detection unit, an identification unit, a determination unit, and a sharing processing unit. The detection unit detects a first moving body that is possibly outside the range of control based on an image or a signal acquired within a predetermined region. The identification unit identifies whether the first moving body is a control target based on control information shared with other control system. In a case where the first moving body is not identified as the control target, the determination unit determines whether an avoidance operation of a second moving body that is the control target is necessary based on a position or a movement of the first moving body. The sharing processing unit shares control information including information related to whether the avoidance operation is necessary, with the other control system.

In an information processing method according to the present disclosure, a computer executes the following processing. The computer detects the first moving body that is possibly outside the range of control based on the image or the signal acquired within the predetermined region. The computer identifies whether the first moving body is the control target based on the control information shared with the other control system. In a case where the first moving body is not identified as the control target, the computer determines whether the avoidance operation of the second moving body that is the control target is necessary based on the position or the movement of the first moving body. The computer shares the control information including the information related to whether the avoidance operation is necessary, with the other control system.

A program according to the present disclosure causes the computer to execute the following method. The computer detects the first moving body that is possibly outside the range of control based on the image or the signal acquired within the predetermined region. The computer identifies whether the first moving body is the control target based on the control information shared with the other control system. In a case where the first moving body is not identified as the control target, the computer determines whether the avoidance operation of the second moving body that is the control target is necessary based on the position or the movement of the first moving body. The computer shares the control information related to whether the avoidance operation is necessary, with the other control system.

According to the present disclosure, it is possible to provide a navigation control system, an information processing method, and a program that can suitably use information related to a status of a moving body that is a control target.

### BRIEF DESCRIPTION OF DRAWINGS

FIG. 1 is a block diagram of a navigation control system according to an example embodiment.

FIG. 2 is a flowchart of a navigation control method according to the example embodiment.

FIG. 3 is a diagram illustrating a usage status of the navigation control system according to the example embodiment.

FIG. 4 is a block diagram of the navigation control system according to the example embodiment.

FIG. 5 is a block diagram of a base station.

FIG. 6 is a block diagram of a moving body.

FIG. 7 is a flowchart of the navigation control method according to the example embodiment.

FIG. 8 is a diagram illustrating content of an identification signal transmitted from the moving body.

FIG. 9 is a diagram illustrating an example of determining whether the moving body is a control target.

FIG. 10 is a diagram illustrating the usage status of the navigation control system according to the example embodiment.

FIG. 11 is a block diagram of the navigation control system according to the example embodiment.

FIG. 12 is a block diagram of an integrated control system.

FIG. 13 is a diagram illustrating the usage status of the navigation control system according to the example embodiment.

FIG. 14 is a block diagram of the navigation control system according to the example embodiment.

FIG. 15 is a flowchart of the navigation control method according to the example embodiment.

FIG. 16 is a block diagram illustrating a hardware configuration of a computer.

### EXAMPLE EMBODIMENT

Hereinafter, the present invention will be described through example embodiments of the invention, but the invention according to the claims is not limited to the following example embodiments. In addition, not all the configurations described in the example embodiments are essential as means for solving the problem. For clarity of description, the following description and drawings are omitted and simplified as appropriate. In each drawing, the same elements are denoted by the same reference numerals, and redundant description is omitted as necessary.

### first Example Embodiment

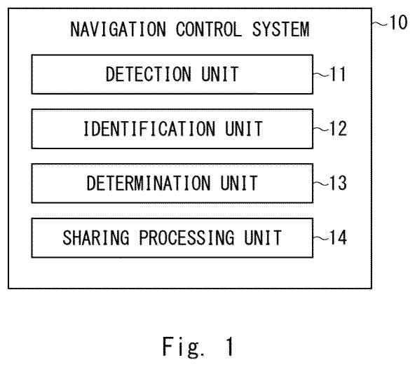

Hereinafter, the present example embodiment will be described with reference to the drawings. FIG. 1 is a block diagram of a navigation control system 10 according to a first example embodiment. The navigation control system 10 is a system for controlling navigation of a moving body. The moving body in the present disclosure is a flying object that moves at an altitude of several meters to several hundred meters from the ground. The moving body is, for example, an unmanned aerial vehicle called a drone or an UAS. The moving body is used for various purposes such as transportation of luggage, observation of the ground, security, or capturing images. The navigation control system 10 controls a navigation status of the moving body that is a control target and detects a possibility that the navigation status of the moving body becomes unsafe.

More specifically, for example, in a case where there is a possibility that the moving body that is the control target collides with a moving body (another moving body) that is not the control target, the navigation control system 10 detects that it is necessary to avoid this moving body. The navigation control system 10 is a computer, a server, or a dedicated terminal that has a communication function and an arithmetic processing function. The navigation control system 10 includes a detection unit 11, an identification unit 12, a determination unit 13, and a sharing processing unit 14, as main components.

The detection unit 11 has a function for detecting a first moving body within a predetermined region. The predetermined region is a region where the moving body controlled by the navigation control system 10 moves. That is, the moving body according to the present disclosure moves in a preset region. The first moving body is a moving body that is possibly outside the range of control of the navigation control system 10. For example, the detection unit 11 acquires image data of an image captured by a predetermined camera and detects the first moving body that is possibly outside the range of control, from the image data. Alternatively, the detection unit 11 acquires a predetermined radio signal transmitted from the first moving body and detects the first moving body that is possibly outside the range of control from this signal.

The identification unit 12 identifies whether the first moving body detected by the detection unit 11 is a control target. At this time, the identification unit 12 performs the identification using control information. The control information is information shared with other control system and includes information related to navigation of a moving body controlled by each control system. That is, the navigation control system 10 shares the control information with the plurality of different control systems so as to share the information regarding the moving bodies that are separately controlled. As a result, the navigation control system 10 can plan a navigation plan of the moving body controlled by the navigation control system 10 without interfering with another moving body. Alternatively, the navigation control system 10 can smoothly control the navigation of the moving body, after grasping a behavior of the moving body controlled by others. Note that the other control system is a system operated by an administrator different from the administrator of the navigation control system 10. The other control system has a function similar to the navigation control system 10.

In a case where the first moving body is not identified as the control target, the determination unit 13 determines whether an avoidance operation of a second moving body that is a control target is necessary. Here, the second moving body is a moving body controlled by the navigation control system 10. The navigation control system 10 supplements a movement of the second moving body. In addition, the determination unit 13 measures a movement of the first moving body and calculates a possibility that the first and second moving bodies come into contact or collide with each other. In addition, the determination unit 13 determines whether the avoidance operation of the second moving body is necessary. In other words, for example, in a case where the possibility that the first and the second moving bodies come into contact or collide with each other is equal to or more than a predetermined threshold, the determination unit 13 determines that an operation for avoiding the second moving body from the first moving body is necessary.

The sharing processing unit 14 shares the control information with the other control system. The control information includes information related to whether the avoidance operation is necessary. For example, the sharing processing unit 14 may notify the other control system communicably connected of that the first moving body that is not the control target is detected. Alternatively, the sharing processing unit 14 may notify that the avoidance operation of the second moving body is necessary, when the first moving body approaches. Alternatively, in a case where a storage apparatus that is accessible by the other control system is communicably connected to the navigation control system 10, the sharing processing unit 14 may store the control information in this storage apparatus.

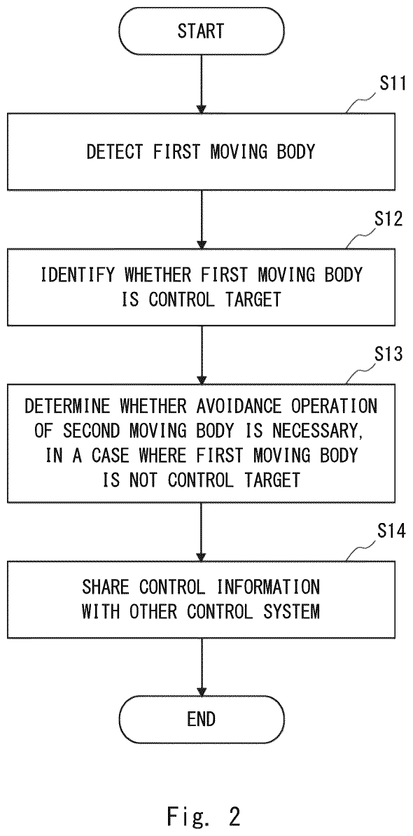

Next, processing executed by the navigation control system 10 will be described with reference to FIG. 2. FIG. 2 is a flowchart of a navigation control method according to the first example embodiment. The flowchart illustrated in FIG. 2 starts, for example, when the detection unit 11 acquires any signal.

First, the detection unit 11 detects the first moving body that is possibly outside the range of control based on an image or a signal acquired within the predetermined region (step S11). When detecting the first moving body, the detection unit 11 supplies a signal indicating the detection of the first moving body to the identification unit 12.

Next, the identification unit 12 identifies whether the first moving body is the control target based on the control information shared with the other control system (step S12). The identification unit 12 supplies a signal indicating whether the first moving body is the control target to the determination unit 13.

Next, in a case where the first moving body is not identified as the control target, the determination unit 13 determines whether the avoidance operation of the second moving body that is the control target is necessary based on a position or a movement of the first moving body (step S13). The determination unit 13 generates information related to whether the avoidance operation is necessary, using a result of this determination and supplies the information to the sharing processing unit 14.

Next, the sharing processing unit 14 shares the control information including the information related to whether the avoidance operation is necessary, with the other control system (step S14). When the sharing processing unit 14 executes processing for sharing the control information with the other control system, the navigation control system 10 ends the series of processing.

The information processing method executed by the navigation control system 10 has been described above. Through such processing, the navigation control system 10 grasps a status of the moving body that is the control target and shares this status with the other control system.

Note that the navigation control system 10 may include a processor and a storage apparatus as components (not illustrated). The storage apparatus included in the navigation control system 10 includes, for example, a storage apparatus including a nonvolatile memory such as a flash memory or an SSD. In this case, the storage apparatus included in the navigation control system 10 stores a computer program (hereinafter, also simply referred to as a program) for executing the above-described image processing method. In addition, the processor reads the computer program from the storage apparatus into a buffer memory such as a dynamic random access memory (DRAM), and executes the program.

Each component included in the navigation control system 10 may be implemented by dedicated hardware. Some or all of the components may be implemented by general-purpose or dedicated circuitry, a processor, or the like, or a combination thereof. These may be configured by a single chip or may be configured by a plurality of chips connected via a bus. Some or all of the components of each apparatus may be implemented by a combination of the above-described circuit or the like and a program. Furthermore, as the processor, a central processing unit (CPU), a graphics processing unit (GPU), a field-programmable gate array (FPGA), or the like may be used. Note that the description regarding the configuration described here can also be applied to other apparatuses or systems described below in the present disclosure.

As described above, according to the present example embodiment, it is possible to provide the navigation control system, the information processing method, and the program that can suitably use the information related to the status of the moving body that is the control target.

### Second Example Embodiment

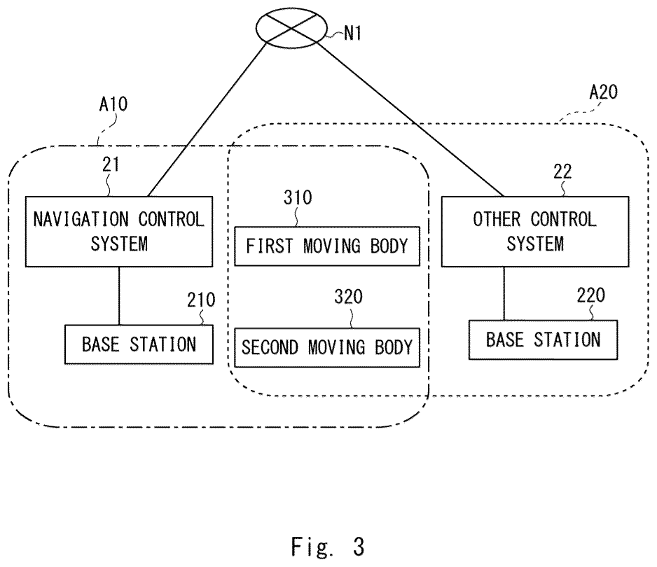

Next, a second example embodiment will be described. FIG. 3 is a diagram illustrating a usage status of a navigation control system according to the second example embodiment. FIG. 3 illustrates a navigation control system 21, other control system 22, a base station 210, a base station 220, a first moving body 310, and a second moving body 320.

The navigation control system 21 controls navigation of a moving body that is a control target in a predetermined first region A10. The navigation control system 21 is communicably connected to the base station 210 and acquires a signal related to the moving body from the base station 210. The navigation control system 21 is communicably connected to the other control system 32 via a network N1.

The navigation control system 21 and the other control system 22 share information regarding moving bodies controlled by the control systems. That is, the navigation control system 21 provides information such as an identification number or a navigation plan of the moving body of which navigation is directly controlled by the navigation control system 21, to the other control system 22. Similarly, the other control system 22 provides information such as an identification number or a navigation plan of the moving body of which navigation is directly controlled by the other control system 22, to the navigation control system 21. With such a configuration, the navigation control system 21 can handle navigation information related to the moving body controlled by the other control system 22, as a control target.

Moreover, the navigation control system 21 and the other control system 22 share control information with each other. That is, in a case of detecting a moving body that is not the control target, the navigation control system 21 and the other control system 22 may share information related to this moving body.

The base station 210 receives an identification signal transmitted from a moving body that moves in the first region A10. Upon receiving the identification signal from the moving body, the base station 210 supplies the received identification signal to the navigation control system 21. Regarding the received identification signal, the base station 210 may further supply additional information such as received radio wave strength to the navigation control system 21. Although the single base station 210 is illustrated in the first region A10 in the present disclosure, the number of base stations is not limited to one. The two or more base stations 210 may exist in the first region A10.

The other control system 22 controls navigation of the moving body that is the control target in a predetermined second region A20. The other control system 22 is communicably connected to the base station 220 that receives the identification signal transmitted from the moving body in the second region A20.

In the configuration described above, a part of the first region A10 managed by the navigation control system 21 and a part of the second region A 20 managed by the other control system 22 overlap. In FIG. 3, in this overlapping region, the first moving body 310 moves. Similarly, in a region where the first region A10 and the second region A20 overlap in FIG. 3, the second moving body 320 moves.

In the situation described above, the navigation control system 21 identifies whether each of the first moving body 310 and the second moving body 320 is the control target. Then, for example, in a case where the first moving body 310 is not the control target and the second moving body 320 is the control target, it is determined whether the second moving body 320 needs to avoid the first moving body 310. Then, the navigation control system 21 supplies control information including the result of this determination to the other control system 22. On the other hand, in a case where the other control system 22 has a function similar to the navigation control system 21, the other control system 22 supplies information related to whether the avoidance of the second moving body 320 is necessary, to the navigation control system 21.

As a result, the navigation control system 21 and the other control system 22 share the control information with each other. With such a configuration, the navigation control system 21 can quickly recognize safety of the moving body that is the control target, within a predetermined region. Therefore, the navigation control system 21 can instruct an avoidance operation of the moving body that is the control target, using the control information.

In the configuration described above, the navigation control system 21 may exist outside the first region A10. However, for example, in a case where the navigation control system 21 and the base station 210 exist in an environment where communication can be performed in a local high-speed communication network, quick information processing can be performed. Therefore, it is preferable that the navigation control system 21 and the base station 210 exist in a predetermined communication network. In this case, the navigation control system 21 may have, for example, a function as multi-access edge computing (MEC).

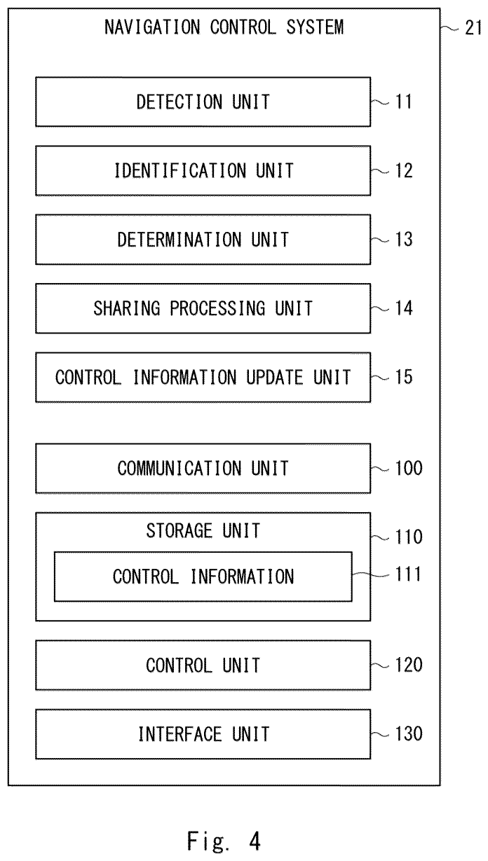

Next, a configuration of the navigation control system 21 will be described with reference to FIG. 4. FIG. 4 is a block diagram of the navigation control system according to the second example embodiment. The navigation control system 21 further includes a control information update unit 15, a communication unit 100, a storage unit 110, a control unit 120, and an interface unit 130, in addition to the detection unit 11, the identification unit 12, the determination unit 13, and the sharing processing unit 14 described in the first example embodiment.

The detection unit 11 according to the present example embodiment acquires identification information of the first moving body 310 supplied from the base station 210 and supplies this identification information to the identification unit 12. The identification unit 12 compares this identification information with control information stored in the storage unit 110. As a result, the identification unit 12 identifies whether the first moving body 310 is the control target. As a result, the navigation control system 10 suitably recognizes the moving body that is outside the range of control.

The determination unit 13 according to the present example embodiment calculates a possibility that the first moving body 310 and the second moving body 320 come into contact with each other from position information included in the identification information. The possibility that the first moving body 310 and the second moving body 320 come into contact with each other may be, for example, calculated according to a distance between the first moving body 310 and the second moving body 320. Furthermore, in a case where it is possible to measure a moving direction and speed in addition to the position of the moving body, the possibility that the first moving body 310 and the second moving body 320 come into contact with each other may be calculated using a movement vector.

In this case, in a case where the calculated value is higher than a predetermined threshold, the determination unit 13 determines that the avoidance operation is necessary. Moreover, the sharing processing unit 14 shares information including that the avoidance operation is necessary, with the other control system, as the control information. As a result, the navigation control system 10 can suitably share information related to the moving body that is outside the range of control.

The detection unit 11 according to the present example embodiment may acquire image data obtained by imaging the first moving body 310 and identify whether the first moving body 310 is the control target using this. In this case, for example, the navigation control system 21 may acquire an FPV image (that is, first-person image, FPV is first person view) captured by a camera included in the second moving body 320 that is the control target.

In this case, the identification unit 12 estimates at least one of a position and a type of the first moving body 310 from the image data of the FPV image and compares the estimation result with the control information. As a result, the identification unit 12 identifies whether the first moving body 310 is the control target. More specifically, the identification unit 12 identifies whether the first moving body 310 is the control target, by estimating whether the first moving body 310 in the image data is included in a predetermined range of a planned route of the moving body that is the control target included in the control information. As a result, the navigation control system 10 suitably recognizes the moving body in accordance with the image data, instead of the identification information of the moving body. That is, even if the moving body that is outside the range of control does not transmit the identification information, the navigation control system 10 suitably recognizes the moving body.

In a case where the FPV image is used, the determination unit 13 calculates the possibility that the first moving body 310 and the second moving body 320 come into contact with each other from the estimated position of the first moving body 310. Then, in a case where the calculated value is higher than the predetermined threshold, the determination unit 13 determines that the avoidance operation is necessary. In this case, the sharing processing unit 14 shares information including that the avoidance operation is necessary, with the other control system. As a result, the navigation control system 10 can suitably notify the administrator of that the avoidance operation of the moving body is necessary.

As described above, in a case where the second moving body 320 is a control target of the other control system, the sharing processing unit 14 shares the information related to whether the avoidance operation is necessary, with the other control system, as the control information shared by the plurality of control systems. As a result, the navigation control system 10 can suppress decrease in safety of the moving body under control using the information shared with each other.

In a case where update of the control information is necessary, the control information update unit 15 manages processing for updating the control information. For example, the control information update unit 15 reflects the control information on which sharing processing is newly executed by the sharing processing unit 14, on control information 111 stored in the storage unit 110.

The communication unit 100 includes an interface used to communicate with the other control system 22 and the base station 210 that are communicably connected to the navigation control system 21. The navigation control system 21 communicates with the other control system 22 and the base station 210 via the communication unit 100.

The storage unit 110 includes a nonvolatile memory such as a flash memory or a solid state drive (SSD). The storage unit 110 stores the control information 111 shared with and updatably controlled by the other control system.

The control unit 120 includes an arithmetic apparatus such as a CPU and controls each configuration of the navigation control system 21. The control unit 120 may contain other configurations included in the navigation control system 21. For example, the control unit 120 may include all or some of the detection unit 11, the identification unit 12, the determination unit 13, the sharing processing unit 14, and the control information update unit 15.

The interface unit 130 includes an information input/output apparatus for a user who uses the navigation control system 21 to use the navigation control system 21. That is, the interface unit 130 may include a display for presenting predetermined information to the user. Furthermore, the interface unit 130 may include an information input apparatus such as a keyboard or a touch panel for receiving an operation from the user.

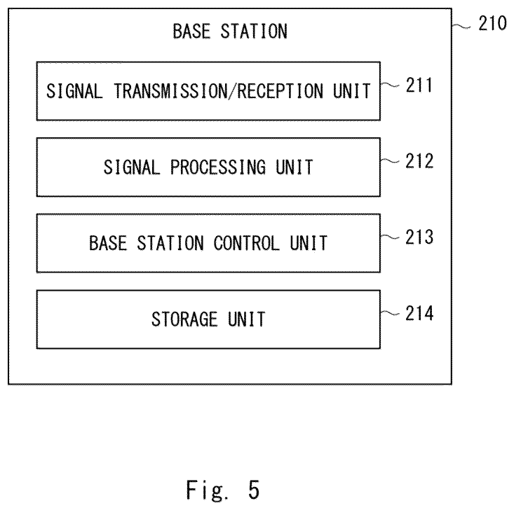

Next, a configuration of the base station will be described with reference to FIG. 5. FIG. 5 is a block diagram of the base station 210. Although FIG. 5 illustrates the configuration of the base station 210, the base station 220 also has a similar configuration. The base station 210 includes a signal transmission/reception unit 211, a signal processing unit 212, a base station control unit 213, and a storage unit 214, as main components.

The signal transmission/reception unit 211 includes an antenna for receiving a signal transmitted from the first moving body 310 or the second moving body 320. In a case where the base station 210 and the navigation control system 21 perform wireless communication, the base station 210 performs communication via the signal transmission/reception unit 211. Upon receiving the identification signal from the first moving body 310 or the second moving body 320, the signal transmission/reception unit 211 supplies the received identification signal to the signal processing unit 212.

The signal processing unit 212 performs encoding, decoding, or the like of signals to be transmitted/received. Furthermore, the signal processing unit 212 generates a base station signal in cooperation with the base station control unit 213. The base station control unit 213 includes an arithmetic apparatus that controls each configuration of the base station 210. The base station control unit 213 generates the base station signal from the identification signal in cooperation with the signal processing unit 212 and supplies the generated base station signal to the navigation control system 21.

The storage unit 214 includes a nonvolatile memory such as a flash memory and stores a program for executing the processing in the present disclosure. Furthermore, the storage unit 214 may have a function as a ring buffer that stores an identification signal after a time point going back a predetermined period.

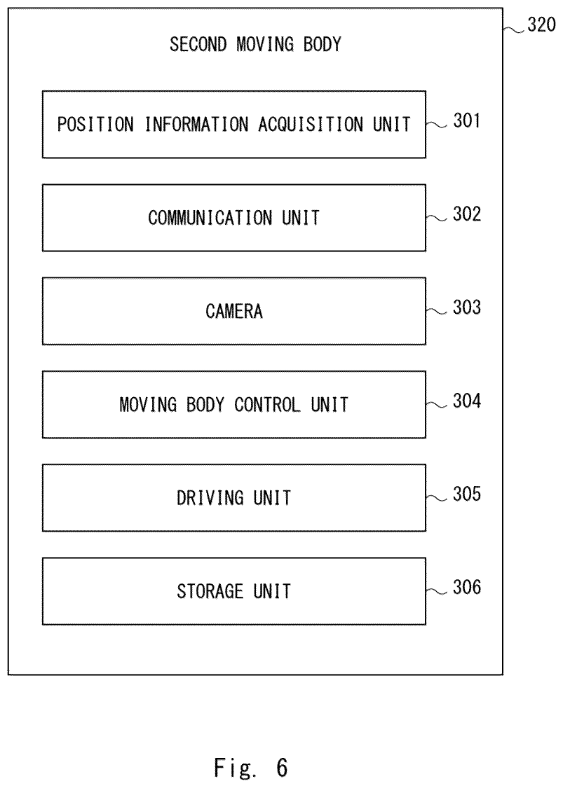

Next, a configuration of the moving body will be described with reference to FIG. 6. FIG. 6 is a block diagram of the second moving body 320. The second moving body 320 includes a position information acquisition unit 301, a communication unit 302, a camera 303, a moving body control unit 304, a driving unit 305, and a storage unit 306, as main components.

The position information acquisition unit 301 acquires position information of the second moving body 320, for example, using a global navigation satellite system (GNSS), a position information acquisition system using Wi-Fi radio waves, or the like. The communication unit 302 has a function for performing direct wireless communication with the base station 210. That is, the communication unit 302 may include, for example, an antenna, a modulation circuit, a demodulation circuit, or the like. The camera 303 includes an objective lens, an image capturing element, or the like and generates image data of an FPV image obtained by imaging a landscape around the second moving body 320.

The moving body control unit 304 includes an arithmetic apparatus such as a CPU or an MCU and controls each configuration of the second moving body 320. That is, for example, the moving body control unit 304 exchanges information with the base station 210 via the communication unit 302 and issues an instruction to each configuration of the second moving body 320, in response to this. The driving unit 305 includes a motor for rotating a propeller that is moving means of the second moving body 320. The storage unit 306 includes a nonvolatile memory such as a flash memory or an SSD and stores identification information of the second moving body 320 or the like.

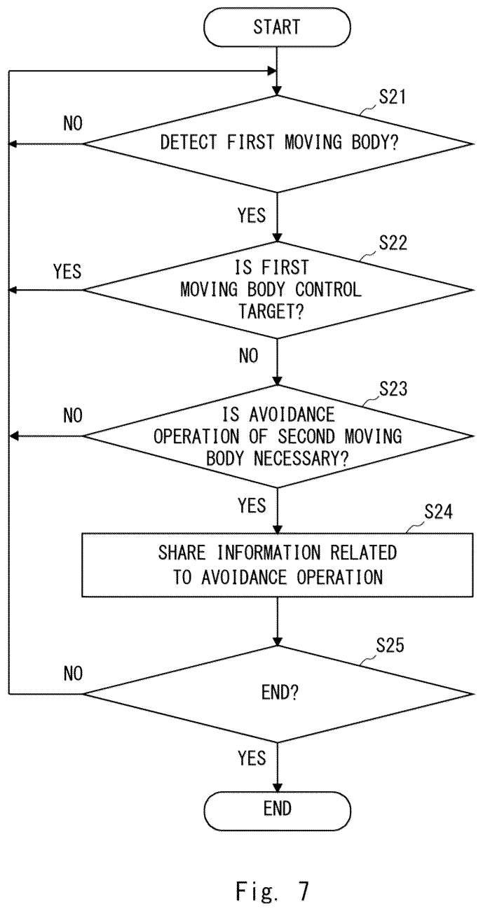

Next, processing executed by the navigation control system 10 according to the present example embodiment will be described with reference to FIG. 7. FIG. 7 is a flowchart of a navigation control method according to the second example embodiment. The processing illustrated in FIG. 7 may start, for example, when the navigation control system 21 is activated.

First, the detection unit 11 determines whether the first moving body 310 that is possibly outside the range of control is detected based on an image or a signal acquired in the first region A10 (step S21). In a case where it is not determined that the first moving body 310 is detected (step S21: NO), the detection unit 11 repeats step S21. In a case where it is determined that the first moving body 310 is detected (step S21: YES), the detection unit 11 proceeds to step S22. At this time, the detection unit 11 supplies a signal indicating that the first moving body 310 is detected to the identification unit 12.

In step S22, it is identified whether the first moving body 310 is the control target with reference to the control information (step S12). Here, in a case where it is identified that the first moving body 310 is the control target (step S12: YES), the navigation control system 21 returns to step S 21. On the other hand, in a case where it is not identified that the first moving body 310 is the control target (step S12: NO), that is, in a case where the identification unit 12 determines that the first moving body 310 is not the control target, the navigation control system 21 proceeds to step S 23. At this time, the identification unit 12 supplies a signal indicating that the first moving body is not the control target, to the determination unit 13.

In step S23, the determination unit 13 determines whether the avoidance operation of the second moving body 320 that is the control target is necessary based on the position or the movement of the first moving body (step S23). In a case where it is not determined that the avoidance operation of the second moving body is necessary (step S23: NO), the navigation control system 21 returns to step S21. On the other hand, in a case where it is determined that the avoidance operation of the second moving body 320 is necessary (step S23: YES), the navigation control system 21 proceeds to step S24. At this time, the determination unit 13 generates information related to the avoidance operation and supplies the information to the sharing processing unit 14.

In step S24, the sharing processing unit 14 shares control information including the information related to whether the avoidance operation is necessary, with the other control system (step S24). In a case where the sharing processing unit 14 executes processing for sharing the control information with the other control system, the navigation control system 10 proceeds to step S25.

In step S25, the navigation control system 21 determines whether to end the series of processing (step S25). A case where the series of processing is ended is, for example, a case where an administrator of the navigation control system 21 performs an operation for ending the processing or the like. In a case where it is not determined that the series of processing is ended (step S25: NO), the navigation control system 21 returns to step S21. On the other hand, in a case where it is determined that the series of processing is ended (step S25: YES), the navigation control system 21 ends the series of processing.

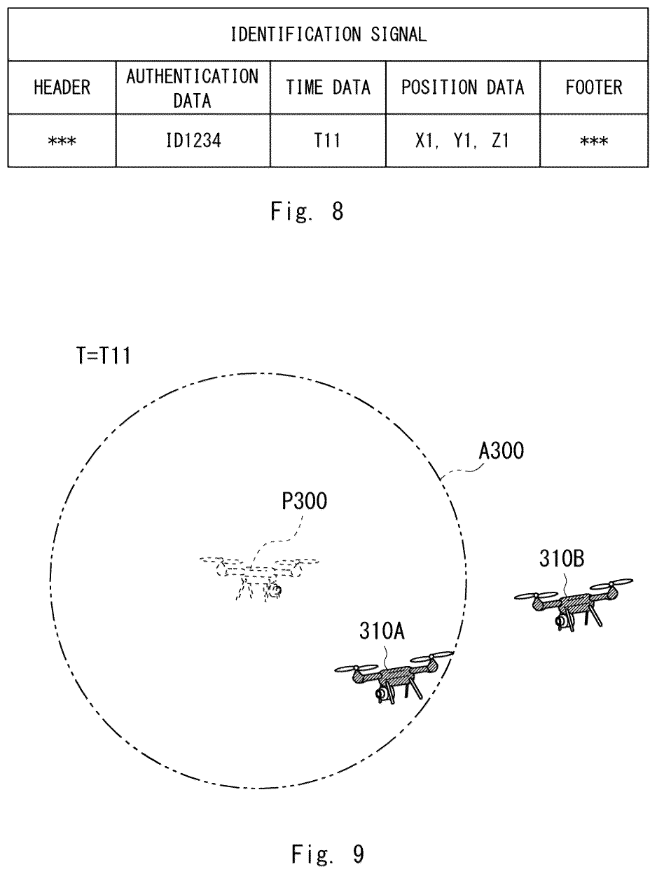

Next, an identification signal transmitted from the moving body will be described. FIG. 8 is a diagram illustrating content of the identification signal transmitted from the first moving body 310 or the second moving body 320. The identification signal is, for example, a signal transmitted from the moving body at a frequency of about once in several hundred milliseconds. The identification signal includes, for example, information indicating that the moving body is moving with permission. Furthermore, the identification signal includes authentication data for authenticating the moving body. The identification signal includes a time when the identification signal is transmitted and position data of the moving body at a time when the identification signal is transmitted.

The identification signal includes a header, authentication data, time data, position data, and a footer, as main components. The header and the footer conform to a predetermined communication protocol for the base station to recognize the identification signal. The authentication data includes data indicating that the moving body that transmits the identification signal is an authenticated moving body. The authentication data may include, for example, an authentication number issued by a predetermined authorized organization such as a local government and a unique identifier associated with the navigation control system 21. The time data is a time stamp updated each time when the identification signal is transmitted. The position data includes, for example, data related to a latitude, a longitude, and an altitude. The position data may also include data indicating a moving velocity.

For example, the first moving body 310 transmits authentication data “ID1234”, time data “T11”, position data “X1, Y1, Z1”, and the footer after the header. Upon receiving this signal, the base station 210 supplies this signal to the navigation control system 21. At this time, the base station 210 may also supply signal strength of the received signal to the navigation control system 21.

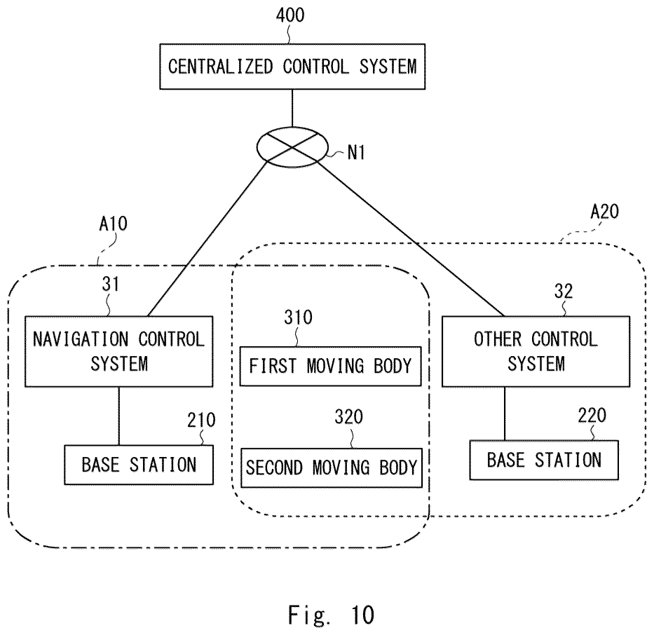

Next, a method for determining whether the moving body is the control target by the navigation control system 21 will be described, with reference to FIG. 9. FIG. 9 is a diagram illustrating an example of determining whether the moving body is the control target. In FIG. 9, a planned position P300 of the moving body is indicated by a dotted line. Around the planned position P300, an allowable range A300 for the planned position P300 is indicated by an alternate long and two short dashes line. The allowable range A300 is a range where it is determined that a moving body that is planned to exist in the planned position P300 may exist.

That is, for example, in a case of detecting the first moving body 310, it is assumed that the navigation control system 21 measure that the first moving body 310 exists within the range of the allowable range A300. In this case, the navigation control system 21 determines the first moving body 310 as the moving body that is the control target. On the other hand, it is assumed to measure that the first moving body 310 exists outside the allowable range A300. In this case, the navigation control system 21 determines the first moving body 310 as the moving body that is not the control target.

For example, a first moving body 310A in FIG. 9 is within the range of the allowable range A300. In this case, the navigation control system 21 recognizes the first moving body 310 as a moving body that moves along a navigation plan. On the other hand, a first moving body 310B in FIG. 9 is outside the range of the allowable range A300. In this case, the navigation control system 21 recognizes the first moving body 310 as a moving body that is outside the range of control.

The identification unit 12 according to the present example embodiment determines whether the position data acquired from the first moving body 310 is included within the predetermined range of the planned route of the moving body that is the control target included in the control information. Then, as a result, the identification unit 12 identifies whether the first moving body 310 is the control target. With the above configuration, the navigation control system 10 suitably recognizes the moving body that is outside the range of control.

In addition to the above configuration, the identification unit 12 may determine at least one of a movement, a specification such as a model name, or an appearance of the first moving body 310, by comparing that with a navigation plan planned in advance.

As described above, according to the present example embodiment, it is possible to provide the navigation control system, an information processing method, and the program that can suitably use information related to a status of the moving body that is the control target.

### Third Example Embodiment

Next, a third example embodiment will be described. FIG. 10 is a diagram illustrating a usage status of a navigation control system according to a third example embodiment. The third example embodiment is different from the above example embodiments in that a centralized control system exists that centrally controls control information shared by the navigation control system.

FIG. 10 includes a centralized control system 400. FIG. 10 includes a navigation control system 31 instead of the navigation control system 21. Similarly, FIG. 10 includes other control system 32 instead of the other control system 22.

The centralized control system 400 is communicably connected to the navigation control system 31 and the other control system 32 via a network N1. For example, the centralized control system 400 receives the control information from the navigation control system 31 and updates the control information that has been already stored, using the received information. Then, the centralized control system 400 supplies the updated control information to the other control system 32. Similarly, the centralized control system 400 receives the control information from the other control system 32 and updates the control information that has been already stored, using the received information. Then, in this case, the centralized control system 400 supplies the updated control information to the navigation control system 31.

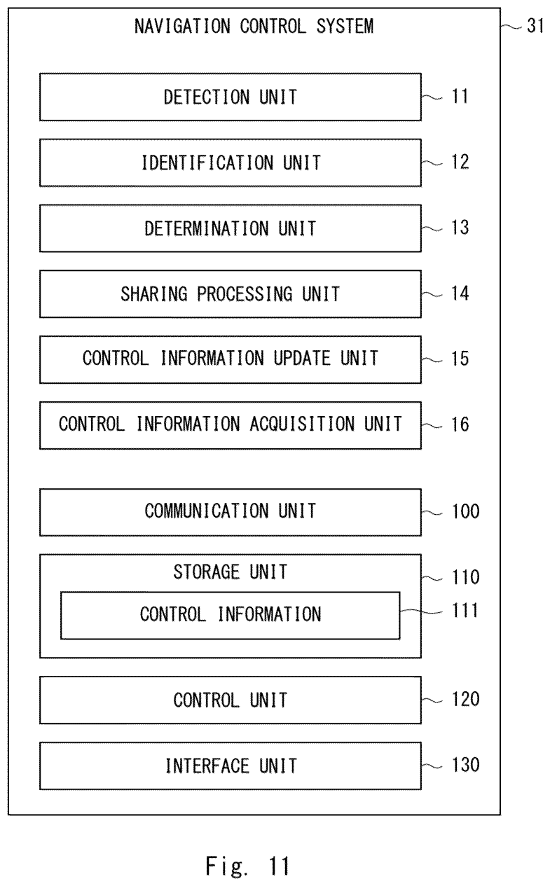

FIG. 11 is a block diagram of the navigation control system 31 according to the third example embodiment. The navigation control system 31 is different from the navigation control system 21 according to the second example embodiment in that a control information acquisition unit 16 is further included.

The control information acquisition unit 16 acquires the control information from the centralized control system 400 that updatably stores the control information. A sharing processing unit 14 according the present example embodiment outputs control information related to whether an avoidance operation is necessary, to the centralized control system 400. As a result, a navigation control system 10 can share the control information with a plurality of navigation control systems, via the centralized control system 400.

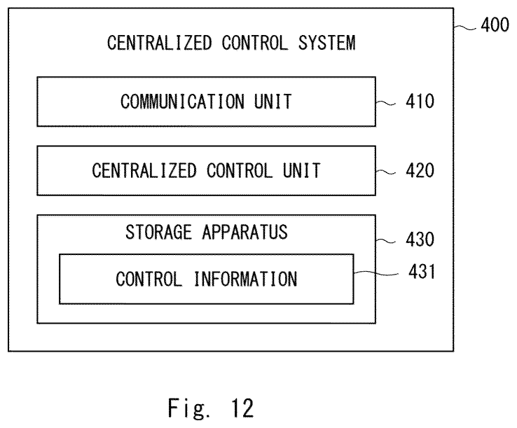

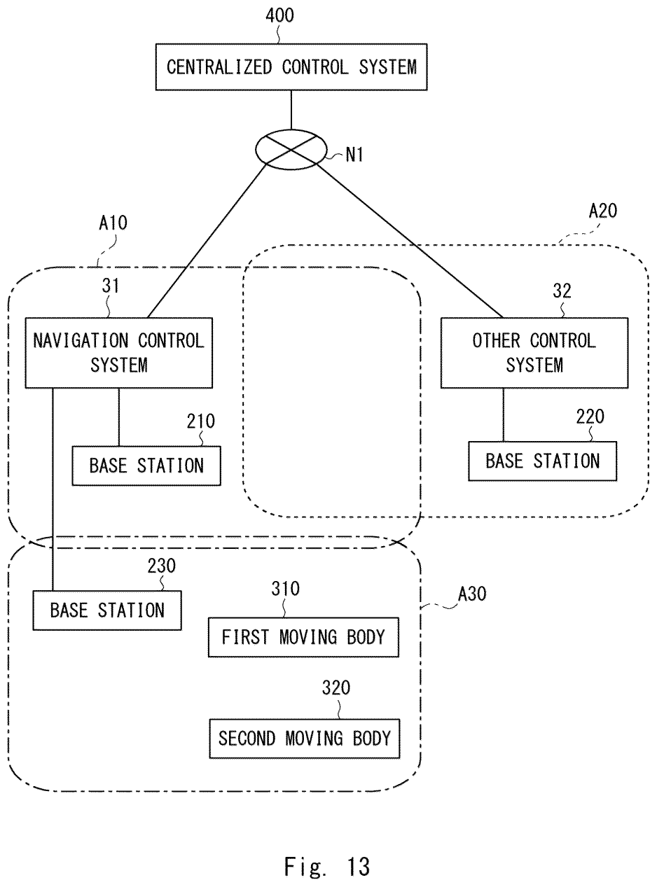

FIG. 12 is a block diagram of the centralized control system 400. The centralized control system 400 is, for example, a computer or a server provided in a predetermined communication network. The centralized control system 400 includes a communication unit 410, a centralized control unit 420, and a storage apparatus 430, as main components.

The communication unit 410 is a communication interface used to communicate with the plurality of navigation control systems such as the navigation control system 31 or the other control system 32, via the network N1. The centralized control unit 420 includes a circuit that executes a program for implementing a function of the centralized control system 400. The storage apparatus 430 includes a nonvolatile memory such as a flash memory or an SSD and stores at least control information 431.

As described above, according to the present example embodiment, it is possible to provide the navigation control system, an information processing method, and the program that can suitably use information related to a status of the moving body that is the control target.

### Fourth Example Embodiment

Next, a fourth example embodiment will be described. FIG. 13 is a diagram illustrating a usage status of a navigation control system according to the fourth example embodiment. A navigation control system 31 illustrated in FIG. 13 is different from the navigation control system 31 according to the third example embodiment in that a base station 230 that manages a third region A 30 is further included. The base station 230 is a base station that controls navigation of a moving body existing in the third region A30 and is set to receive an identification signal transmitted from the moving body existing in the third region A30. In the example illustrated here, a part of the third region A30 overlaps a part of a first region A10. However, the third region A30 does overlap a second region A20.

In the situation described above, in FIG. 13, a first moving body 310 and a second moving body 320 exist in the third region A30. The navigation control system 31 achieves a function similar to the example embodiments described above in the third region A30, by receiving the identification signal from the base station 230. That is, the navigation control system 31 detects the first moving body 310 existing in the third region A30 and identifies whether the first moving body 310 is a control target. Furthermore, the navigation control system 31 determines whether the second moving body 320 that is the control target needs to perform an avoidance operation.

However, the navigation control system 31 according to the present example embodiment does not share the detection of the first moving body 310 that is not the control target in the third region A30, with the other control system 32. This is because there is no moving body managed by the other control system 32 in the third region A30. That is, the navigation control system 31 according to the present example embodiment includes a region where the control information is shared with the other control system 32 and a region where the control information is not shared with the other control system 32.

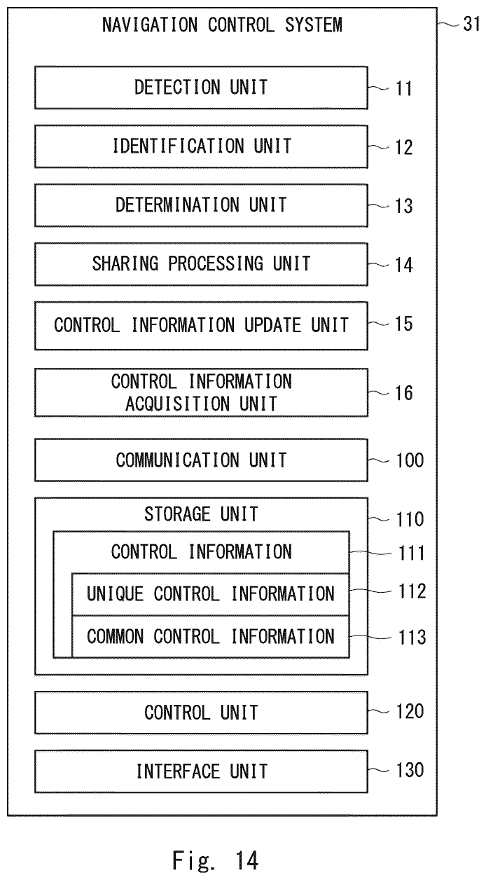

FIG. 14 is a block diagram of the navigation control system 31 according to the fourth example embodiment. The navigation control system 31 according to the present example embodiment has a mode of control information 111 stored in a storage unit 110, different from the third example embodiment.

In a case where the second moving body 320 is the control target of the other control system 32, a sharing processing unit 14 according to the present example embodiment shares information related to whether the avoidance operation is necessary, with the other control system 32. In other words, in a case where the second moving body 320 is not the control target of the other control system 32, the sharing processing unit 14 does not share this control information with the other control system 32. With such a configuration, the navigation control system 31 suitably shares necessary control information with the other control system, appropriately.

The control information 111 according to the present example embodiment includes unique control information 112 and common control information 113. The unique control information 112 is control information that is not shared with the other control system 32. In a case of the example in FIG. 13, the navigation control system 31 controls information related to an event occurred in the third region A 30, as the unique control information 112.

On the other hand, the common control information 113 is control information shared with the other control system 32. The common control information 113 according to the present example embodiment is, for example, information related to an event occurred in the second region A20. The navigation control system 31 supplies the common control information 113 to the centralized control system 400.

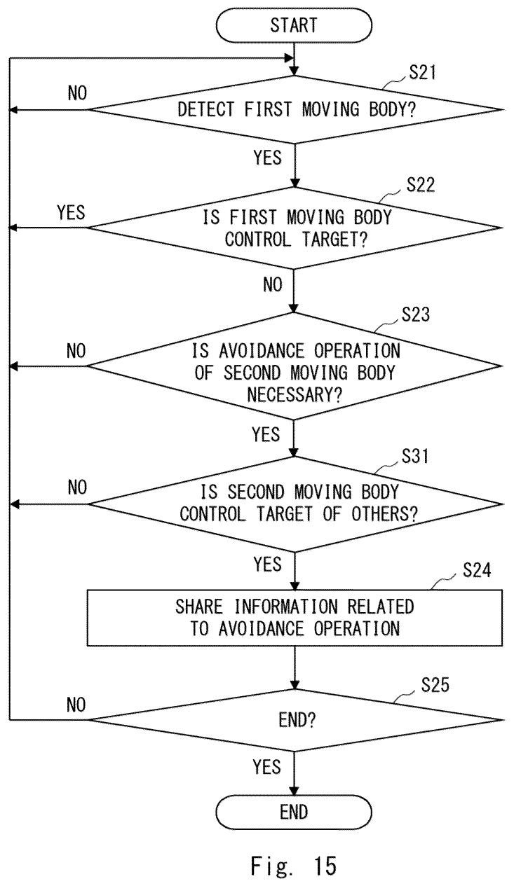

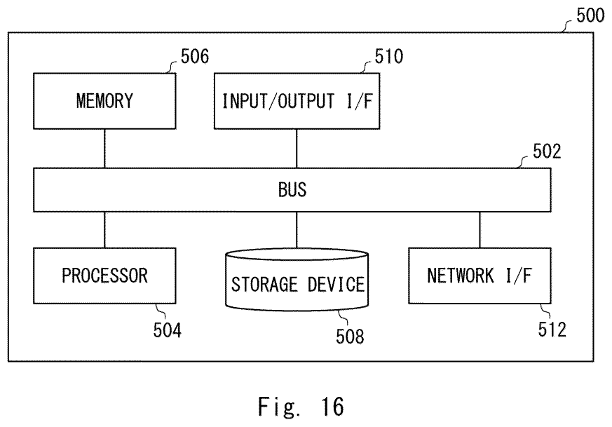

FIG. 15 is a flowchart of a navigation control method according to the fourth example embodiment. The flowchart illustrated in FIG. 15 is different from the flowchart illustrated in FIG. 7 in that step S31 is included between steps S23 and S24.

In step S 23, a determination unit 13 determines whether the avoidance operation of the second moving body 320 that is the control target is necessary based on a position or a movement of the first moving body (step S23). In a case where it is not determined that the avoidance operation of the second moving body is necessary (step S23: NO), the navigation control system 21 returns to step S21. On the other hand, in a case where it is determined that the avoidance operation of the second moving body 320 is necessary (step S23: YES), the navigation control system 21 proceeds to step S31. At this time, the determination unit 13 generates information related to the avoidance operation and supplies the information to the sharing processing unit 14.

In step S31, the sharing processing unit 14 determines whether the second moving body 320 is a control target of the other control system (step S31). In a case where it is determined that the second moving body 320 is the control target of the other control system (step S31: YES), the navigation control system 31 proceeds to step S24. On the other hand, in a case where it is not determined that the second moving body 320 is the control target of the other control system (step S31: NO), the navigation control system 31 returns to step S21.

The processing executed by the navigation control system 31 has been described above. The processing executed by the sharing processing unit 14 according to the present example embodiment is not limited to the content described above. For example, the sharing processing unit 14 may read identification information of the second moving body 320 and share the control information in a case where the identification information is the control target of the other control system 32. Alternatively, the sharing processing unit 14 may share the control information with a control system related to a position where the moving body is detected, regardless of which control system controls the moving body. Alternatively, the sharing processing unit 14 may determine whether to share the control information, according to whether a time band when the moving body is detected, at a place where the moving body is detected, is the control target of the control system.

As described above, according to the example embodiment, it is possible to provide the navigation control system, an information processing method, and a program that can suitably use information related to a status of the moving body that is the control target.

### Example of Hardware Configuration

Hereinafter, a case will be described where a functional configuration of each of an update information generation apparatus and a static information control apparatus according to the present disclosure is implemented by a combination of hardware and software.

FIG. 16 is a block diagram illustrating a hardware configuration of a computer. The update information generation apparatus and the static information control apparatus according to the present disclosure can implement the above function by a computer 500 having an illustrated hardware configuration. The computer 500 may be a portable computer such as a smartphone or a tablet terminal or may be a stationary computer such as a PC.

The computer 500 may be a dedicated computer designed to implement each apparatus, or may be a general-purpose computer. The computer 500 can implement a desired function by installing a predetermined application.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, the method of connecting the processor 504 and the like to each other is not limited to the bus connection.

The processor 504 is various processors such as a CPU, a GPU, or an FPGA. The memory 506 is a primary storage device implemented by using a random access memory (RAM) or the like.

The storage device 508 is an auxiliary storage device implemented by using a hard disk, an SSD, a memory card, a read only memory (ROM), or the like. The storage device 508 stores a program for implementing a desired function. The processor 504 reads the program to the memory 506 and executes the program to implement each functional component of each apparatus.

The input/output interface 510 is an interface connecting the computer 500 and an input/output device. For example, an input device such as a keyboard and an output device such as a display device are connected to the input/output interface 510.

The network interface 512 is an interface connecting the computer 500 to a network.

While the invention of the present application has been particularly shown and described with reference to example embodiments thereof, the invention of the present application is not limited to the above. It will be understood by those of ordinary skill in the art that various changes in form and details may be made therein without departing from the spirit and scope of the invention as defined by the claims.

Some or all of the above example embodiments may be described as the following supplementary notes, but are not limited to the following.

### Supplementary Note 1

A navigation control system including:
a detection unit for detecting a first moving body that is possibly outside the range of control based on an image or a signal acquired within a predetermined region;
an identification unit for identifying whether the first moving body is a control target based on control information shared with other control system;
a determination unit for determining whether an avoidance operation of a second moving body that is the control target is necessary based on a position or a movement of the first moving body, in a case where the first moving body is not identified as the control target; and
a sharing processing unit for sharing control information including information related to whether the avoidance operation is necessary with the other control system.

### Supplementary Note 2

The navigation control system according to Supplementary Note 1, in which
the detection unit acquires identification information of the first moving body, and
the identification unit identifies whether the first moving body is the control target by comparing the identification information with the control information.

### Supplementary Note 3

The navigation control system according to Supplementary Note 2, in which the identification unit identifies whether the first moving body is the control target, by determining whether position data acquired from the first moving body is included within a predetermined range of a planned route of a moving body that is the control target included in the control information.

### Supplementary Note 4

The navigation control system according to Supplementary Note 2, in which
the determination unit calculates a possibility that the first moving body and the second moving body come into contact with each other from position information included in the identification information and determines that the avoidance operation is necessary in a case where the calculated value is higher than a predetermined threshold, and
the sharing processing unit shares information including that the avoidance operation is necessary, with the other control system.

### Supplementary Note 5

The navigation control system according to Supplementary Note 1, in which
the detection unit acquires image data obtained by imaging the first moving body, and
the identification unit estimates at least one of a position and a type of the first moving body from the image data and identifies whether the first moving body is the control target by comparing an estimation result with the control information.

### Supplementary Note 6

The navigation control system according to Supplementary Note 5, in which the identification unit identifies whether the first moving body is the control target, by estimating whether the first moving body in the image data is included within a predetermined range of a planned route of a moving body that is the control target included in the control information.

### Supplementary Note 7

The navigation control system according to Supplementary Note 5, in which
the determination unit calculates a possibility that the first moving body and the second moving body come into contact with each other from the estimated position of the first moving body and determines that the avoidance operation is necessary in a case where the calculated value is higher than a predetermined threshold, and
the sharing processing unit shares information including that the avoidance operation is necessary, with the other control system.

### Supplementary Note 8

The navigation control system according to any one of Supplementary Notes 1 to 7, in which in a case where the second moving body is the control target of the other control system, the sharing processing unit shares information related to whether the avoidance operation is necessary, with the other control system.

### Supplementary Note 9

The navigation control system according to any one of Supplementary Notes 1 to 7, further including a storage apparatus configured to store the control information that is shared with and updatably controlled by the other control system.

### Supplementary Note 10

The navigation control system according to any one of Supplementary Notes 1 to 7, further including a control information acquisition unit for acquiring the control information from a centralized control system that updatably stores the control information,

in which the sharing processing unit outputs the information related to whether the avoidance operation is necessary, to the centralized control system.

### Supplementary Note 11

A navigation control method by a computer including:
detecting a first moving body that is possibly outside the range of control based on an image or a signal acquired within a predetermined region;
identifying whether the first moving body is a control target based on control information shared with other control system;
determining whether an avoidance operation of a second moving body that is the control target is necessary based on a position or a movement of the first moving body, in a case where the first moving body is not identified as the control target; and
sharing control information including information related to whether the avoidance operation the second moving body is necessary with the other control system.

### Supplementary Note 12

A program for causing a computer to execute a navigation control method including:
detecting a first moving body that is possibly outside the range of control based on an image or a signal acquired within a predetermined region;
identifying whether the first moving body is a control target based on control information shared with other control system;
determining whether an avoidance operation of a second moving body that is the control target is necessary based on a position or a movement of the first moving body, in a case where the first moving body is not identified as the control target; and
sharing control information including information related to whether the avoidance operation of the second moving body is necessary with the other control system.

Some or all of the elements (such as configurations and functions, for example) described in Supplementary Notes 2 to 10 depending from Supplementary Note 1 may depend from Supplementary Notes 11 and 12 as well with depending relationships similar to those of Supplementary Notes 2 to 10. Some or all of the elements described in any Supplementary Note may be applied to various types of hardware, software, recording means for recording software, systems, and methods.

This application is based upon and claims the benefit of priority from Japanese patent application No. 2023-042219, filed on Mar. 16, 2023, the disclosure of which is incorporated herein in its entirety by reference.

### INDUSTRIAL APPLICABILITY

The present disclosure can be used for a control apparatus, a control system, or the like that controls navigation of a moving body, for example, a drone or the like.

### REFERENCE SIGNS LIST

10 navigation control system
11 detection unit
12 identification unit
14 sharing processing unit
15 control information update unit
16 control information acquisition unit
21 navigation control system
22 other control system
31 navigation control system
32 other control system
100 communication unit
110 storage unit
111 control information
112 unique control information
113 common control information
120 control unit
130 interface unit
210 base station
211 signal transmission/reception unit
212 signal processing unit
213 base station control unit
214 storage unit
220 base station
230 base station
301 position information acquisition unit
302 communication unit
303 camera
304 moving body control unit
305 driving unit
306 storage unit
310 first moving body
320 second moving body
321 moving body
322 moving body
400 centralized control system
410 communication unit
430 storage apparatus
431 control information
500 computer
502 bus
504 processor
506 memory
508 storage device
510 input/output interface
512 network interface
N1 network
A10 first region
A20 second region
A30 third region

What is claimed is:

1. A navigation control system comprising:
a memory storing instructions; and
a processor configured to execute the instructions to:
detect a first moving body that is possibly outside the range of control based on an image or a signal acquired within a predetermined region;
identify whether the first moving body is a control target based on control information shared with another control system;
determine whether an avoidance operation of a second moving body that is the control target is necessary based on a position or a movement of the first moving body, in a case where the first moving body is not identified as the control target; and
share control information including information related to whether the avoidance operation is necessary with the another control system.

2. The navigation control system according to claim 1, wherein
the processor configured to execute the instructions to acquire identification information of the first moving body, and
identify whether the first moving body is the control target by comparing the identification information with the control information.

3. The navigation control system according to claim 2, wherein the processor configured to execute the instructions to identify whether the first moving body is the control target, by determining whether position data acquired from the first moving body is included within a predetermined range of a planned route of a moving body that is the control target included in the control information.

4. The navigation control system according to claim 2, wherein
the processor configured to execute the instructions to calculate a possibility that the first moving body and the second moving body come into contact with each other from position information included in the identification information and determine that the avoidance operation is necessary in a case where the calculated value is higher than a predetermined threshold, and
share information including that the avoidance operation is necessary, with the another control system.

5. The navigation control system according to claim 1, wherein
the processor configured to execute the instructions to acquire image data obtained by imaging the first moving body, and
estimate at least one of a position and a type of the first moving body from the image data and identifies whether the first moving body is the control target by comparing an estimation result with the control information.

6. The navigation control system according to claim 5, wherein the processor configured to execute the instructions to identify whether the first moving body is the control target, by estimating whether the first moving body in the image data is included within a predetermined range of a planned route of a moving body that is the control target included in the control information.

7. The navigation control system according to claim 5, wherein
the processor configured to execute the instructions to calculate a possibility that the first moving body and the second moving body come into contact with each other from the estimated position of the first moving body and determine that the avoidance operation is necessary in a case where the calculated value is higher than a predetermined threshold, and
share information including that the avoidance operation is necessary, with the another control system.

8. The navigation control system according to claim 1, wherein in a case where the second moving body is the control target of the another control system, the processor configured to execute the instructions to share information related to whether the avoidance operation is necessary, with the another control system.

9. The navigation control system according to claim 1, further comprising a storage apparatus configured to store the control information that is shared with and updatably controlled by the another control system.

10. The navigation control system according to claim 1, further the processor configured to execute the instructions to acquire the control information from a centralized control system that updatably stores the control information, and
output the information related to whether the avoidance operation is necessary, to the centralized control system.

11. A navigation control method by a computer comprising:
detecting a first moving body that is possibly outside the range of control based on an image or a signal acquired within a predetermined region;
identifying whether the first moving body is a control target based on control information shared with another control system;
determining whether an avoidance operation of a second moving body that is the control target is necessary based on a position or a movement of the first moving body, in a case where the first moving body is not identified as the control target; and
sharing control information including information related to whether the avoidance operation of the second moving body is necessary with the another control system.

12. The navigation control method according to claim 11, wherein
the navigation control method acquires identification information of the first moving body, and
identifies whether the first moving body is the control target by comparing the identification information with the control information.

13. The navigation control method according to claim 12, wherein the navigation control method identifies whether the first moving body is the control target, by determining whether position data acquired from the first moving body is included within a predetermined range of a planned route of a moving body that is the control target included in the control information.

14. The navigation control method according to claim 12, wherein
the navigation control method calculates a possibility that the first moving body and the second moving body come into contact with each other from position information included in the identification information and determines that the avoidance operation is necessary in a case where the calculated value is higher than a predetermined threshold, and
shares information including that the avoidance operation is necessary, with the another control system.

15. The navigation control method according to claim 11, wherein
the navigation control method acquires image data obtained by imaging the first moving body, and
estimates at least one of a position and a type of the first moving body from the image data and identifies whether the first moving body is the control target by comparing an estimation result with the control information.

16. The navigation control method according to claim 15, wherein the navigation control method identifies whether the first moving body is the control target, by estimating whether the first moving body in the image data is included within a predetermined range of a planned route of a moving body that is the control target included in the control information.

17. The navigation control method according to claim 15, wherein
the navigation control method calculates a possibility that the first moving body and the second moving body come into contact with each other from the estimated position of the first moving body and determines that the avoidance operation is necessary in a case where the calculated value is higher than a predetermined threshold, and
shares information including that the avoidance operation is necessary, with the another control system.

18. The navigation control method according to claim 11, wherein in a case where the second moving body is the control target of the other another control system, the navigation control method shares information related to whether the avoidance operation is necessary, with the another control system.

19. The navigation control method according to claim 11, wherein the navigation control method stores the control information that is shared with and updatably controlled by the another control system.

20. A non-transitory computer readable medium storing a program for causing a computer to execute a navigation control method comprising:
detecting a first moving body that is possibly outside the range of control based on an image or a signal acquired within a predetermined region;
identifying whether the first moving body is a control target based on control information shared with another control system;
determining whether an avoidance operation of a second moving body that is the control target is necessary based on a position or a movement of the first moving body, in a case where the first moving body is not identified as the control target; and
sharing control information including information related to whether the avoidance operation of the second moving body is necessary with the another control system.
